(19) United States
(12) Patent Application Publication
(10) Pub. No.: US 2006/0137494 A1
(43) Pub. Date: Jun. 29, 2006

(54) Wrench with guiding means at the jaws

(76) Inventor: Arthur Wu, Shen Kang Hsiang (TW)

Correspondence Address: John H. Thomas, P.C., 536 Granite Avenue, Richmond, VA, 23226, US

(21) Appl. No.: 10/319,480

(22) Filed: Dec. 16, 2002

(51) Int. Cl. B25B 13/02

(52) U.S. Cl. 81/119

(57) ABSTRACT

A wrench has a handle, a first jaw and a second jaw. The first jaw and the second jaw each has a holding face and two sidewalls respectively connected to the holding face at two sides. Each edge between the holding faces and the sidewalls of the first and the second jaws respectively has a guiding portion thereon. The guiding portions are chamfer or fillets. Whereby the distance between the interior sides of the guiding portions, which are connecting to said holding faces, of said first jaw and said second jaw is smaller than the distance between the exterior sides of said guiding portions, which are connecting to said sidewalls, of said first jaw and said second jaw. The guiding portions will enlarge the coupling range of the wrench.

### FIELD OF THE INVENTION

The present invention relates to hand tools, and more particularly to a wrench with a guiding means at the jaws.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the Wrench with Guiding Means at the Jaws according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a top view of a conventional prior art open-endeded wrench, showing coupling the jaws of the open-ended wrench with a bolt;

FIG. 2 is a front side view of a part of an open-ended wrench of a first preferred embodiment of the present invention, showing the two jaws of the wrench;

FIG. 3 is a sketch view in part of the open-ended wrench of the first preferred embodiment of the present invention;

FIG. 4 is a top view of the open-ended wrench of the first preferred embodiment of the present invention, showing the jaws intending to couple with a bolt;

FIG. 5 is a top view in part of an open-ended wrench of a second preferred embodiment of the present invention;

FIG. 6 is a front side view in part of an open-ended wrench of a second preferred embodiment of the present invention;

FIG. 7 is an end elevational view of an open-ended wrench of a third preferred embodiment of the present invention; and

FIG. 8 is an end elevational view of an adjustable wrench which is a fourth preferred embodiment of the present invention.

### BACKGROUND OF THE INVENTION

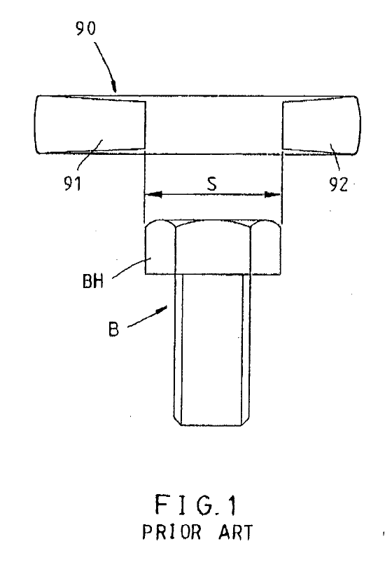

When using a wrench, for example, an open-ended wrench, to turn a nut or bolt, the jaws of the wrench must be accurately introduced to the nut or the head of the bolt for the nut or the head of the bolt received in between the jaws of the wrench. Typically, after each stroke of turning, the wrench must be removed from the workpiece and then the jaws must be re-introduced to the workpiece again for another stroke of turning. As illustrated in FIG. 1, the distance S between the jaws 91 and 92 is the opening dimension of the open-ended wrench 90. The distance S must be slightly greater than the size of the head BH of the Bolt B. So that the jaws 91 and 92 can be coupled with the head BH of the bolt B. When coupling the jaws 91 and 92 to the head BH of the bolt B, a user must accurately aim the wrench 90 to the head BH of the bolt B.

However, an open-ended wrench having a relatively wider dimension between the jaws 91 and 92 tends to be slightly loose on the workpiece and therefore can damage the workpiece during the turning. An open-ended wrench having a relatively smaller mouth between the jaws (only slightly greater than the size of the workpiece) does not damage the workpiece during turning but cannot be easily coupled to the workpiece.

Conventional combination wrenches and adjustable wrenches also have the same problem.

The primary objective of the present invention is to provide a wrench that is easily introduced to a workpiece, yet engages the workpiece snugly enough to preclude damage during turning.

### SUMMARY OF THE INVENTION

According to the present invention, there is provided a wrench comprising a handle having a first jaw and a second jaw at one end of the handle. The first jaw and the second jaw each have a holding face and two sidewalls respectively connected to the holding face at two sides thereof. Each of the first and the second jaws has two guiding portions respectively disposed at the edges between the holding face and the sidewalls. The distance between the interior sides of the guiding portions of the first and the second jaws is smaller than the distances of the exterior sides of the guiding portions, which connect the sidewalls of the first and the second jaws.

### DETAILED DESCRIPTION OF A PREFERRED EMBODIMENT

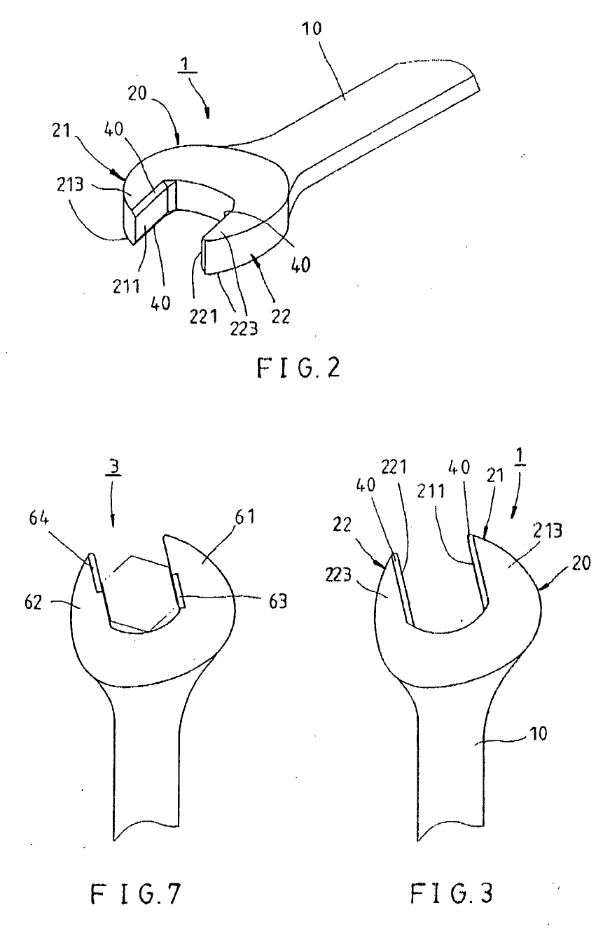

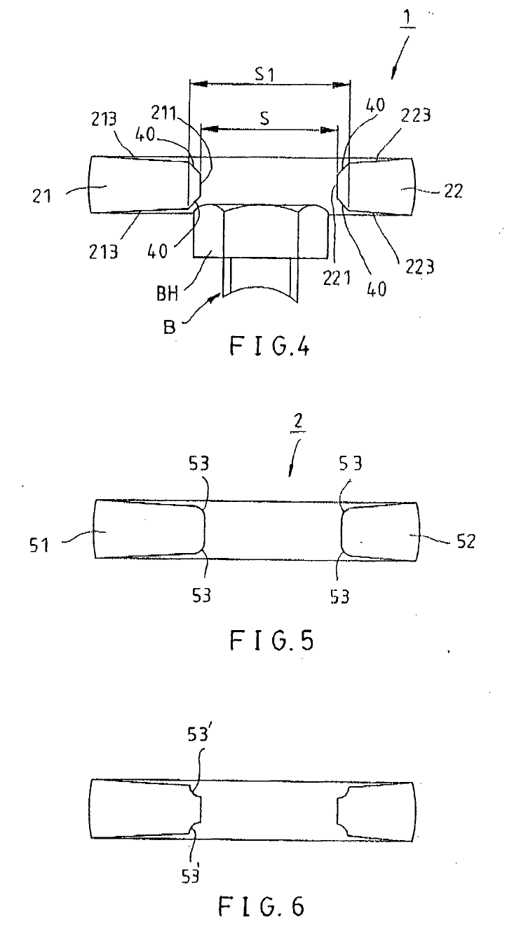

Referring to FIGS. 2 and 3, an open-ended wrench 1 of the first preferred embodiment comprises a handle 10, and two open ends 20 at each of the two ends of the handle 10 (only one open end is shown in FIG. 2). The open end 20 comprises a first jaw 21 and a second jaw 22. The jaws 21 and 22 each has a holding face 211 and 221 facing to each other. The pitch between the holding faces 211 and 221 is the dimension S of the open end 20 (see also FIG. 4). The jaws 21 and 22 each further comprise two parallel sidewalls 213 and 223 respectively connected to the holding face 211 and 221 at two sides and substantially perpendicular to the holding face 211 and 221.

The main feature of the present invention is that each of the jaws 21 and 22 of the open-ended wrench 1 is provided with two guiding portions 40. The guiding portions 40 are provided at the edges between the holding face 211 and 221 and the sidewalls 213 or 223. The guiding portions 40 are 45° chamfers in the present embodiment. The interior sides of the guiding portions 40 are connecting to the holding faces 211 or 221, and the exterior sides of the guiding portions 40 are connecting to the sidewalls 213 or 223. The distance S between the interior sides of the guiding portions 40 of the first and the second jaws 21 and 22 is smaller than the distance S1 between the exterior sides of the guiding portions 40 of the first and the second jaws 21 and 22.

Referring to FIG. 4 again, when coupling the jaws 21 and 22 with a bolt B, it is not necessary to precisely aim the jaws 21 and 22 at the head BH of the bolt B. When the head BH of the bolt B deviated from the area of the distance S between the interior sides of the guiding portions 40 but within the range of the distance S1 between the exterior sides of the guiding portions 40, the head BH of the bolt B can still be guided by the guiding portions 40 to slide in between the holding faces 211 and 221.

In fact, the distance S of the holding faces 211 and 221 is the dimension of the opening end 20 of the wrench 1, which is the original range for the wrench coupling with the nut. The guiding portions 40 of the present invention enlarge the coupling range of the wrench 1 from S to S1. The dimension of the wrench 1 to hold the nut remains at S for preventing the nut being damaged during turning.

FIG. 5 shows an open-ended wrench 2 of the second preferred embodiment of the present invention, which is similar to the first preferred embodiment, except that the guiding portions 53 of the jaws 51 and 52 are fillets in the present embodiment. It will achieve the same effect as that of the aforesaid first embodiment of the present invention.

FIG. 6 shows an alternate guiding portions 53′ respectively smoothly curved inwards.

FIG. 7 shows an open-ended wrench 3 of the third preferred embodiment of the present invention. The wrench 3 has a first jaw 61, a second jaw 62 and guiding portions 63 or 64. The guiding portions 63 are disposed at a part of the edges of the first jaw 61 closing to the proximal end thereof. The guiding portions 64 are disposed at a part of the edges of the second jaw 64 closing to the distal end thereof. When attached to the head of the bolt (shown as the dotted line), the guiding portions 63 and 64 of the jaws 61 and 62 are corresponding to two diagonal angles of the head of the bolt (or the nut). According to this embodiment, the guiding portions 63 and 64 can be chamfers, fillets or curved inward surfaces as described above.

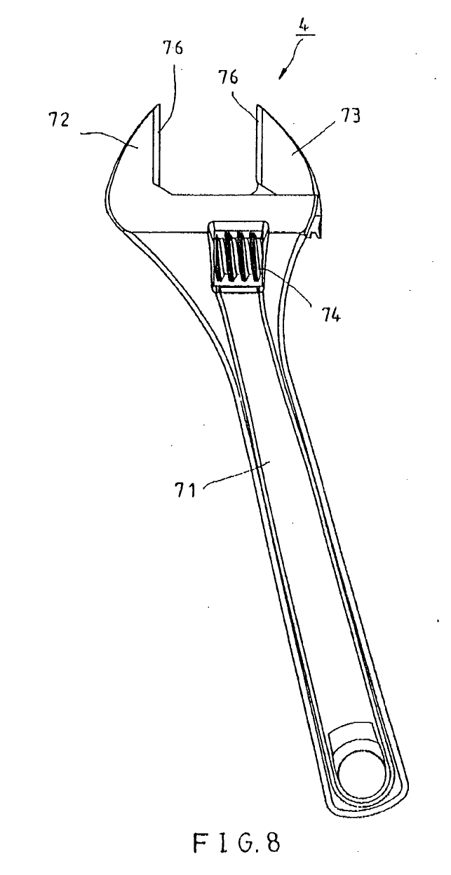

FIG. 8 shows an adjustable wrench 4, which is the fourth preferred embodiment of the present invention. The adjustable wrench 4 has a handle 71, a fixed jaw 72 extended from one end of the handle 71, a moveable jaw slidably engaged to the handle 71, and an adjusting worm gear 74 pivoted at the handle 71 for turning with the thumb to drive the moveable jaw 73 to move relative to the fixed jaw 72. The fixed jaw 72 and the moveable jaw 73 each have two guiding portions 76. The guiding portions 76 can be arranged in the same manner as either of the aforesaid embodiments.

Similarly, the concept of the present invention can be employed to a double open-endeds wrench, a combination wrench, has an open-ended and a box-end thereon.

Prototypes of wrench have been constructed with the features of FIGS. 2 to 8. The wrench functions smoothly to provide all of the features as discussed above.

Although particular embodiments of the invention have been described in detail for purposes of illustration, various modifications and enhancements may be made without departing from the spirit and scope of the invention. Accordingly, the invention is not to be limited except as by the appended claims.

I claim:

1. A wrench, characterized in that it comprises:
a handle, a first jaw and a second jaw provided at one end of said handle;
wherein said first jaw and said second jaw each have a holding face and two sidewalls respectively connected to said holding face at two sides thereof;
wherein each edge of said first and said second jaws between said holding faces and said sidewalls respectively have a guiding portion;
wherein the distance between interior sides of said guiding portions, which are connecting to said holding faces, of said first jaw and said second jaw is smaller than the distance between exterior sides of said guiding portions, which are connecting to said sidewalls, of said first jaw and said second jaw.

2. The wrench as claimed in claim 1, characterized in that said guiding portions are chamfers.

3. The wrench as claimed in claim 1, characterized in that said guiding portions are fillets.

4. The wrench as claimed in claim 1, characterized in that said guiding portions are surfaces smoothly curved inwards.

5. The wrench as claimed in claim 1, characterized in that said guiding portions of said first jaw are respectively disposed at a part of the edges between said holding face and said sidewalls, and said guiding portions of said second jaw are respectively disposed at a part of the edges between said holding face and said sidewalls.

6. The wrench as claimed in claim 1, characterized in that said guiding portions of said first jaw are disposed at a position closing to the distal end of said first jaw, and said guiding portions of said second jaw are disposed at a position closing to the proximal end of said second jaw.

7. The wrench as claimed in claim 1, characterized in that the wrench is an open-ended wrench.

8. The wrench as claimed in claim 1, characterized in that the wrench is a combination wrench.

9. The wrench as claimed in claim 1, characterized in that the wrench is an adjustable wrench, which has a fixed jaw and a moveable jaw, and said first jaw and said second jaw are the fixed jaw and moveable jaw of the adjustable wrench.
